(19) United States
(12) Patent Application Publication
(10) Pub. No.: US 2015/0324152 A1
(43) Pub. Date: Nov. 12, 2015

(54) Network Printing System and Printing Method

(71) Applicant: Sitao DING, Beijing (CN)

(72) Inventor: Sitao DING, Beijing (CN)

(21) Appl. No.: 14/703,821

(22) Filed: May 4, 2015

(30) Foreign Application Priority Data
May 6, 2014 (CN) 201410187390.8

(51) Int. Cl. G06F 3/12

(52) U.S. Cl. CPC G06F 3/126; G06F 3/1285

(57) ABSTRACT

A network print server includes: a print task memory configured to store a print task list; a printing device registration unit configured to establish, in response to a VPN connection request comprising VPN parameters from a printing device, a VPN connection to the printing device via a VPN server, register the printing device and create in the print task memory a print task list corresponding to the printing device, the VPN parameters comprising an IP address of the VPN server and a domain name of the printing device, wherein the domain name of the printing device is bound to the hardware id of the printing device; and a print task management unit configured to receive a print request from a computing device and add a print task entry in the print task list of the requested printing device.

### CROSS-REFERENCE TO RELATED APPLICATIONS

The present application is a continuation of, and claims priority to, Chinese Patent Application No. CN 201410187390.8 filed May 6, 2014, the disclosure of which is hereby incorporated by reference in its entirety.

### BACKGROUND

Printer is a commonly seen device in an office environment, which is mainly operated to print computer-processed results on a related medium. Currently network printing inside a local network becomes ordinary and some organizations, e.g., corporations and schools, even arrange a dedicated printer server enabling a user to install a printer client driver on his/her computer and thus print files (e.g., photos, documents, etc.) stored in the computer using a printer managed by the printer server. Since the computer, the printer and the printer server are all situated within the local network, which form a closed system for the organizations, it is easy to perform the security management and the printing for the print tasks.

However, a print user may also be located outside a local network in many circumstances. For instance, when a user on a business trip browses emails on a portable computing device such as a laptop computer, a smart phone, or a tablet computer, he/she may hope to print the content of the emails on a printer of the hotel where he/she stays. The user may add the device to the local network of the hotel to connect with the printer and install a corresponding printer driver to print the emails. Apparently, this is not convenient because the hotel may not be willing to open its local network to the public, and may also require complicated set-ups even if adding to the local network is allowed for users. Moreover, it often takes time and efforts to seek and install the driver for a certain printer model. In particular when the user uses a mobile terminal like a smart phone, possibly no corresponding driver(s) has/have been developed for such mobile terminals. Nowadays, with the rapid development of mobile internet techniques, the user expects a more flexible and efficient printing implementation, rather than that of the traditional local networks.

At present, there have been approaches of providing printing service via the Internet, where a printer server for controlling the printer is firstly provided, and then an IP address that can be accessed over the Internet is assigned to the printer server, such that the user can send via the Internet the content to be printed directly to the printer server which in turn controls the printer to perform printing. Nevertheless, among these printing approaches, since the printer server is arranged outside the local networks of the organizations (e.g., hotels), transmitting files and messages between an outside and an inside of the organizations via the Internet are often intercepted by all kinds of security devices, and as a result, it needs a plenty of efforts from administrator to solve these problems. Furthermore, some printer servers obtained the IP addresses by e.g. NAT, while such IP addresses may change with an alteration of the network environment, then it would be difficult for the user to determine a currently available IP address of the printer server.

So there is a need for a network printing technique which is more reliable and convenient.

### SUMMARY

The present invention relates to network printing techniques, especially to a network printing system and printing method.

To this end, the present invention provides a new network printing arrangement, a network printing system and a corresponding printing method, in an attempt to solve or at least alleviate the problems above.

According to one aspect of the present invention, a network print server is provided, comprising: a print task memory configured to store a print task list; a printing device registration unit configured to establish, in response to a VPN connection request comprising VPN parameters from a printing device, a VPN connection to the printing device via a VPN server, register the printing device and create in the print task memory a print task list corresponding to the printing device, the VPN parameters comprising an IP address of the VPN server and a domain name of the printing device, wherein the domain name of the printing device is bound to the hardware id of the printing device; and a print task management unit configured to receive a print request from a computing device and add a print task entry in the print task list of the requested printing device, the print task entry comprising a print task ID and print task content. The print task management unit is further configured to receive from a printing device a request to download a print task and send the requested print task to the printing device.

The network print server and the VPN server may be located in the same internal network. The printing device registration unit may be further configured to store a mapping table between the domain name and the printing device, and the print task management unit may be further configured to determine the requested printing device based on the domain name in the print request. The print task management unit may be further configured to push the latest print task ID in the print task list to the corresponding printing device. The VPN connection may be established by n2n.

According to a further aspect of the present invention, a network printing device is provided, comprising: a network initialization unit configured to request a VPN server to establish a VPN connection based on pre-stored VPN parameters and register the printing device at the network print server, wherein the VPN parameters comprise an IP address of the VPN server and a domain name of the printing device, wherein the domain name of the printing device is bound to the hardware id of the printing device; and a print task management unit configured to receive from the network print server the latest print task ID in the print task list, compare the latest print task ID of the printing device provided by the network print server with the current print task ID maintained in the printing device, and request to download a new print task from the network print server if the two print task IDs are inconsistent, the new print task corresponding to the print task ID subsequent to the current print task ID maintained in the printing device.

The network printing device may further comprise a printing unit configured to execute a print task assigned by the print task management unit. The network initialization unit and the print task management unit may be located in a printing box outside of the printing unit. The network initialization unit may be further configured to switch between a VPN connection mode and a non-VPN connection mode. The VPN connection may be established by n2n. The print task management unit may be further configured to receive the latest print task ID in the print task list pushed by the network print server. The network initialization unit may be further configured to test whether the network is smooth prior to the requesting for the establishment of the VPN connection.

According to a further aspect of the present invention, a printing method of a network print server is provided, comprising: establishing, in response to a VPN connection request comprising VPN parameters from a printing device, a VPN connection to the printing device via a VPN server, wherein the VPN parameters comprise an IP address of the VPN server and a domain name of the printing device, wherein the domain name of the printing device is bound to the hardware id of the printing device; registering the printing device and creating in a print task memory a print task list corresponding to the printing device; receiving a print request from a computing device; adding a print task entry in the print task list of the requested printing device, the print task entry comprising a print task ID and print task content; receiving from the printing device a request to download a print task; and sending the requested print task to the printing device.

The network print server and the VPN server may be located in the same internal network. The method may further comprise: storing a mapping table between the domain name and the printing device; and determining the requested printing device based on the domain name in the print request. The method may further comprise pushing the latest print task ID in the print task list to the corresponding printing device. The VPN connection may be established by n2n.

According to a further aspect of the present invention, a printing method of a network printing device is provided, comprising: requesting a VPN server to establish a VPN connection based on pre-stored VPN parameters and registering the printing device at the network print server, wherein the VPN parameters comprise an IP address of the VPN server and a domain name of the printing device, wherein the domain name of the printing device is bound to the hardware id of the printing device; receiving from the network print server the latest print task ID in the print task list; and comparing the latest print task ID of the printing device provided by the network print server with the current print task ID maintained in the printing device, and requesting to download a new print task from the network print server if the two print task IDs are inconsistent, the new print task corresponding to the print task ID subsequent to the current print task ID maintained in the printing device.

The method may further comprise switching between a VPN connection mode and a non-VPN connection mode. The VPN connection may be established by n2n. The receiving step may comprise receiving the latest print task ID in the print task list pushed by the network print server. The method may further comprise testing whether the network is smooth prior to the requesting for the establishment of the VPN connection.

According to a further aspect of the present invention, a network printing system is provided, comprising the above network print server and at least one above network printing device.

In light of the network printing method according to the present invention, computing devices such as mobile terminals may simply print on a printing device via a public network without having to install drivers or join a corporational local network, which greatly facilitates the printing for a user, especially in a mobile environment. Since the printing device and the network print server are in VPN connection, transmitting messages and files can be reliable without being intercepted by security devices like a firewall. Moreover, information such as the IP address of the VPN server is pre-fixed inside the printing device by e.g. burning, such that the VPN dial-up can be initiated immediately upon start-up or connecting to the network and a secure connection with the cloud print server can be established rapidly, which saves the input operation by a user, saves time for the user and avoids problems brought by input errors.

### BRIEF DESCRIPTION OF THE DRAWINGS

To the accomplishment of the foregoing and related ends, certain illustrative aspects are described herein in combination with the following description and the annexed drawings. These aspects are indicative of the various ways in which the principles disclosed herein can be practiced and all aspects and equivalents thereof are intended to be within the scope of the claimed subject matter. The foregoing and other goals, features and advantages of this disclosure will become more apparent from the following detailed description in conjunction with the drawings. Throughout this disclosure, the same reference signs usually refer to the same parts or elements.

FIG. 1 illustrates a schematic view of a cloud printing system 100 according to one embodiment of the present invention;

FIG. 2 illustrates an exemplary n2n VPN architecture;

FIG. 3 illustrates a flow chart of a printing method executed by a printing device according to one embodiment of the present invention;

FIG. 4 illustrates a flow chart of a printing method executed by a cloud print server according to one embodiment of the present invention.

### DETAILED DESCRIPTION

The exemplary embodiments of this disclosure will be described in a more detailed manner as follows with reference to the drawings. Although the exemplary embodiments of this disclosure are shown in the drawings, it should be understood that this disclosure can be implemented in various forms and should not be restricted by the embodiments described herein. On the contrary, these embodiments are provided to make this disclosure more thoroughly understood and the scope of the disclosure fully conveyed to those of skill in the art.

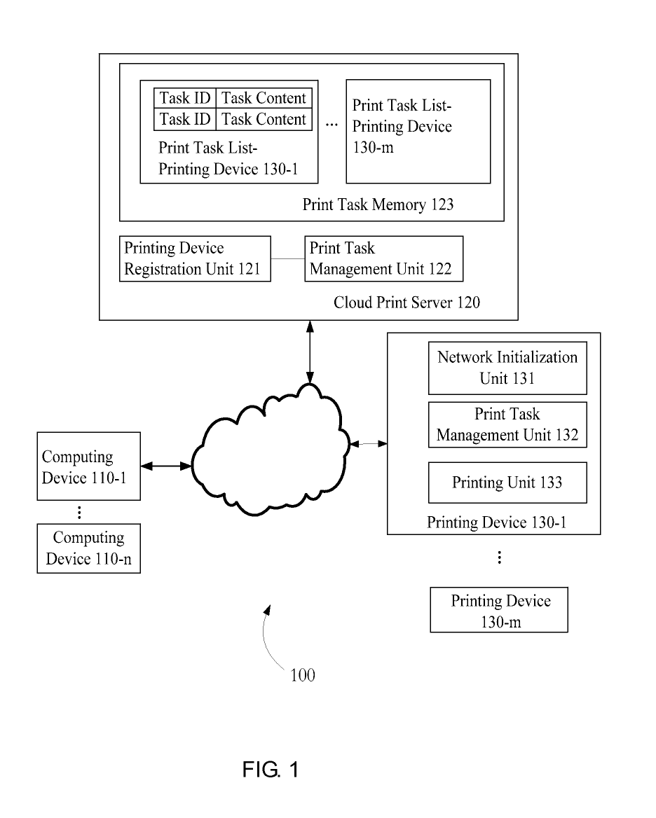

FIG. 1 illustrates a schematic view of a cloud printing system 100 according to an exemplary embodiment of the present invention. As shown in FIG. 1, the cloud printing system 100 comprises one or more computing devices 110-1, 110-2, . . . , 110-n (hereinafter referred to as 110 for the convenience of description) that serve as a cloud print client, a cloud print server 120, one or more printing devices 130-1, 130-2, . . . , 130-m (hereinafter referred to as 130 for the convenience of description). It should be noted that the concept of cloud printing herein is described as an example. In fact, the present invention can be applied to network print servers and printing devices capable of connecting to a network beyond a local network, where different terms or concepts may be used.

The computing device 110 may include a desktop computer, a laptop computer, a smart phone, a tablet computer, etc., and use operation systems such as Windows®, IOS® and Android®. On each computing device 110 an application 111 that supports cloud printing functions is installed. The application 111, for example, may be an APP or a web browser, a word processing software and such like running on the operation system. The computing device 110 has access to the cloud print server 120 via a public network based on various types of communication mechanisms, e.g. in all suitable communications such as Ethernet, Wifi and mobile cellular network.

The cloud print server 120 may represent a plurality of servers or a single server. The cloud print server 120 comprises a printing device registration unit 121, a print task management unit 122 and a print task memory 123. The printing device registration unit 121 may establish, in response to a request from the printing device 130, an initial network connection with the printing device 130, register the printing device 130, and create a print task list corresponding to the printing device 130 in the print task memory 123. For each registered printing device 130, the print task management unit 122 maintains in the print task memory 121 a print task list corresponding to the printing device 130. Each entry in the print task list may comprise a print task ID and print task content. The print task management unit 122 receives a print request from the computing device 110 and creates a new print task entry in the print task list of the requested printing device 130. When there is a new print task for the printing device 130, the print task management unit 122 may initiatively push the print task ID to the printing device 130, so that the printing device 130 may download the print task and print the same. Alternatively, the print task management unit 122 may also return, in response to a request from the printing device 130 for an inquiry of the print task ID, the latest print task ID to the printing device 130, such that the printing device 130 may download the print task and print the same.

Although the print task memory 121 is shown as an entity part of the cloud print server 120, it should be understood that it may represent a cloud memory device composed of a large number of entity storage distributed in different physical locations. In practice, the cloud print system may be implemented by an architecture including a cloud print server/cloud computing center, local thin server (embedded system local server) and printer/cluster of printers. The cluster of printers may include one or more printers using Epson instruction sets.

The printing device 130 comprises a network initialization unit 131, a print task management unit 132 and a printing unit 133. The network initialization unit 131 may establish a network connection between the printing device 130 and the cloud print server 120 such that the printing device 130 has a corresponding IP address for subsequent secure communication. The printing device 130 may get access to a public network and connect to the cloud print server either via a wired and wireless local network inside of a corporation or a business, or via a 3G or 4G cellular network, etc. During this process, the network initialization unit 131 further registers the printing device 130 at the cloud print server 120 so as for the cloud print server 120 to create and maintain a print task list corresponding to the printing device 130. The print task management unit 132 may comprise a web server for receiving the print task ID pushed by the cloud print server 120 and determine whether a new print task exists. Alternatively, the web server can further inquire of, e.g., by polling, the cloud print server 120 periodically about the print task ID. If it is determined that a new print task exists, the print task management unit 132 will download the new print task from the cloud print server 120 and perform the printing by means of the printing unit 133. It should be noted that the printing device 130 may be either an integral printing device capable of establishing connection with the cloud print server 120 and perform the cloud printing, or a traditional printer added further with an extension device with a cloud printing function, e.g., a cloud printing box. For the latter, the cloud printing box may comprise the network initialization unit 131 and the print task management unit 132, while the traditional printer serves as the printing unit 133. The cloud printing box has a driver for the traditional printer installed therein and is connected with the traditional printer by e.g. Universal Serial Bus (USB). In this way, the corporation or business does not have to buy a new cloud printer but needs only to connect a cloud printing box externally to a traditional printer to turn it into a cloud printer, thus the existing printing device is utilized to an utmost extent, and cost is saved. In a further embodiment, a printing box can be connected to a plurality of traditional printers and hence the cost is further saved.

According to one embodiment of the present invention, the network connection is established by way of VPN so as to improve reliability and avoid interception of files and messages between the print server and the printing device by various security devices (e.g., a firewall). VPN is a technique of establishing a dedicated network over a public network. VPN belongs to a remote access technique, e.g., an employee of a corporation who stays out on a business trip wants to access server sources of the internal network of the corporation, and the access belongs to a remote access. In this case, it only needs to construct a VPN server in the internal network of the corporation and provide an external network IP and a dial-up user password for therefore dialing up using the VPN technique outside the corporation, and the computer outside the corporation can be deemed to be situated in the internal network of the corporation. As a result, the firewall is penetrated thereby achieving the goal of accessing an apparatus within the internal network from the external network. However, as the printing device often has not the sufficient processing or I/O capabilities (e.g., a screen and a keyboard) to a general computing device (e.g., a laptop computer, a smart phone, etc.), it is difficult for a user to configure the printing device for the establishment of VPN. For example, the printing device often lacks an I/O component for the user to input IP address, user name and password of the VPN server. Therefore, according to one conception of the present invention, information of the VPN server, e.g., an IP address, is fixed in advance inside the printing device by e.g. burning, such that the VPN dial-up may be initiated immediately upon start-up or connecting to the network and a secure connection with the cloud print server may be established rapidly, which saves the input operation by a user, saves time for the user and avoids problems brought by input errors.

Currently VPN can be implemented in many ways, e.g., based on protocols such as PPTP, L2TP, IPSec, SOCKSv5. In an example of the present invention, the establishment of VPN is carried out by using an open source code n2n (http://www.ntop.org/products/n2n/).

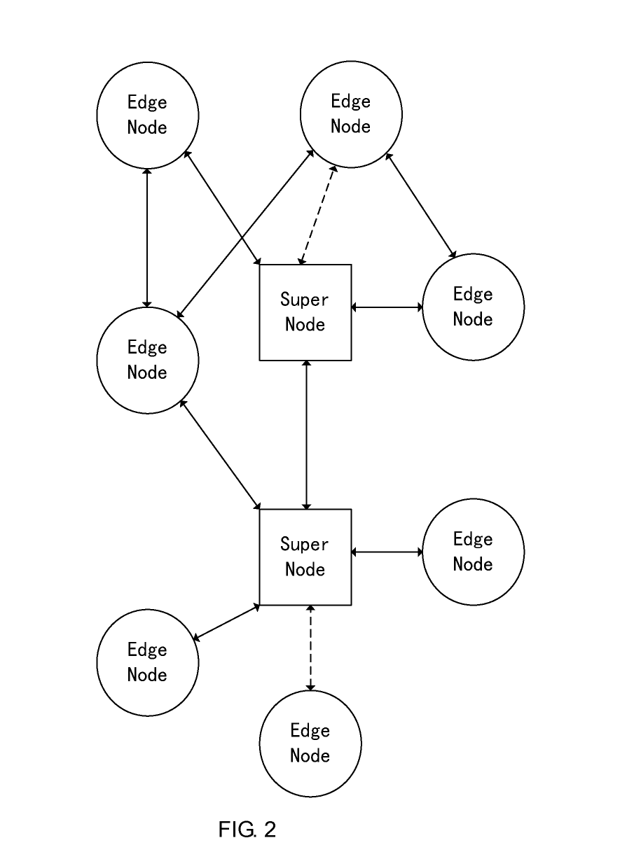

FIG. 2 illustrates an exemplary n2n VPN architecture. The n2n is built on a point-to-point (p2p) architecture, wherein a super node provides a place for two edge nodes behind a NAT/firewall to meet with each other, and once the two parties accomplish the initial handshake, the remnant data streams will occur between the two edge nodes. If the NAT of either party is symmetric, the super node will continue to provide the forwarding of data packets and the edge node will be responsible for the encryption and the decryption of the data streams. For a VPN, two steps are mainly involved, namely encapsulation and encryption-decryption, where the edge nodes are encapsulated by using a UDP protocol for the purpose of a better strategy for compatibility with the firewall, as many firewalls forbid the use of non-TCP/UDP protocols. Twofish is adopted for the encryption algorithm, advantages being source-open, convenient and processing-fast to be thus quite suitable for cloud printing service. In order to reduce the design complexity, n2n utilizes a tap/tun virtual network adapter, which has the advantage that the software is extremely small in size and on the other hand the source code is very much less dependent, so it can be easily transplanted to an embedded device, and is quite suitable for applying to the cloud printing service. There is a wide range of operation systems supported by n2n, including Linux, FreeBSD, MAC OS X, and even Windows. A command format at the client reads as follows: “edge -f -r -a 192.168.230.8-c 12wr34t -k 7877-1 84.86.108.50:82 >/dev/null &”. See also http://www.ntop.org/products/n2n/ for the specific meanings of these command parameters. In particular, the present invention proposes using a printing box for extension over a traditional printer so as to enable support of a cloud printing function, while using n2n which boasts of low calculation complexity and small sized software in the establishment of a VPN connection can simplify the design of the printing box, save cost and facilitate the user's use and subsequent development.

The principle is illustrated below by the example of an implementation of the printing box.

As mentioned above, since the printing box lacks an I/O component for a user to make the VPN setting, it is a comparatively convenient approach to pre-store parameters of VPN in a ROM of the printing box by e.g. burning. These parameters comprise IP address and port of a VPN server, and also IP address or domain name of each printing box. The VPN server can be the same server as the cloud print server, or a different one, and the VPN server and the cloud print server are generally located in the same private network. More than one IP address of the VPN server may be stored for purpose of backup. In a preferred embodiment, each printing box is mapped to one domain name. The http interface API access to the print box can be performed in the manner of domain name, and printing instructions and print tasks may be given to the print box by http. For example, a smart phone user may deliver a printing instruction and a print task while making an order in an ordering application. The domain name may be pre-assigned to the printing box, and a mapping table between the domain name and the printing box is stored in the VPN server/cloud print server so as to have the domain name bound to the hardware id of the printing box. The user may be informed of a domain name of a printing box in many ways. In one of these ways, the printing box would print the domain name and the management background for printing on a startup test page. Alternatively, the domain name of the printing box can be viewed by scanning a two-dimensional code attached on the printing box. For instance, after the code scanning by an application such as WeChat or 360 Security Guard, http://abc002.unifw.com/html5/goto.php?table_id=001 can be viewed on the screen of the mobile terminal, and http://abc002.unifw.com herein is namely the domain name of the printing box. Furthermore, the developer of the application may design a character string composed of characters and/or numbers to serve as a key for local encryption. Since some ordinary key exchange approaches are not reliable and may confront difficulty in their set-ups, the present invention proposes to query the developer by maintenance staff of the cloud print server about the key and then burn the key into the ROM of the printing box. The cloud print server transmits the print content encrypted with the key to the printing box which in turn uses the key to perform decryption. For the developer, there is not required any set-up for the printing box. The burning can be carried out remotely, which greatly improves the convenience.

When the printing box starts up or is connected to the network, the internal client automatically executes a process flow of establishing a VPN network connection. Firstly, the client may test whether the communication link between the print box and the VPN server is smooth, i.e., whether the network is connected. For example, the client sends an http request to the VPN server, and if a http 200 OK status code is retuned, it means that the link is smooth. Then the client makes a VPN dial-up by e.g. n2n using the stored VPN parameters (including the IP address of the VPN server and the domain name of the box) to request to establish a VPN connection. Upon receipt of the request, the VPN server returns a message to indicate that the VPN connection is successfully established. The specific signaling process flow during the establishment of VPN will no longer be discussed in details here. After a successful establishment of VPN, the printing box acquires a VPN internal network address, i.e., it is located in the same private network as the VPN server. The cloud print server is also located in this private network, so the printing box and the cloud print server are located in the same virtual private network which enables secure VPN communications. If the cloud print server and the VPN server do not belong to the same private network, the cloud print server may also be connected to the VPN server via VPN. The cloud print server registers the printing box and creates in the print task memory a print task list corresponding to the printing box. The VPN server or cloud print server stores a mapping table between the domain name and the printing box. When the cloud print server receives a print request from an application, it stores the print task data comprised therein in a print queue Data_In_Q, and maps the domain name therein to the printing box so as to determine which printing box shall execute the printing.

In addition, the connection of the printing box to the cloud print server may be established in many different ways. For instance, the printing box may establish connection directly to the cloud print server via a public network such as 3G network without using VPN. The VPN mode is more secure, but may consume more traffic and may also affect the network speed. According to an embodiment of the present invention, the printing box may switch between a VPN mode and a non-VPN mode. When the printing box is connected to the cloud print server via a cellular network (e.g., 2G or 3G network), the non-VPN mode is preferred. When the printing box is connected to the cloud print server via a wired or a Wifi network, the VPN mode is preferred. When the connection is not successfully established in the VPN mode, it switches to the non-VPN mode. In the VPN mode, the print task ID is sent to the print box by “push” preferably, without worrying about being intercepted by the firewall.

Although the present invention is described in conjunction with the example of a printing box, it should be understood that the principle of the present invention is also applicable to a printing device with a cloud printing function.

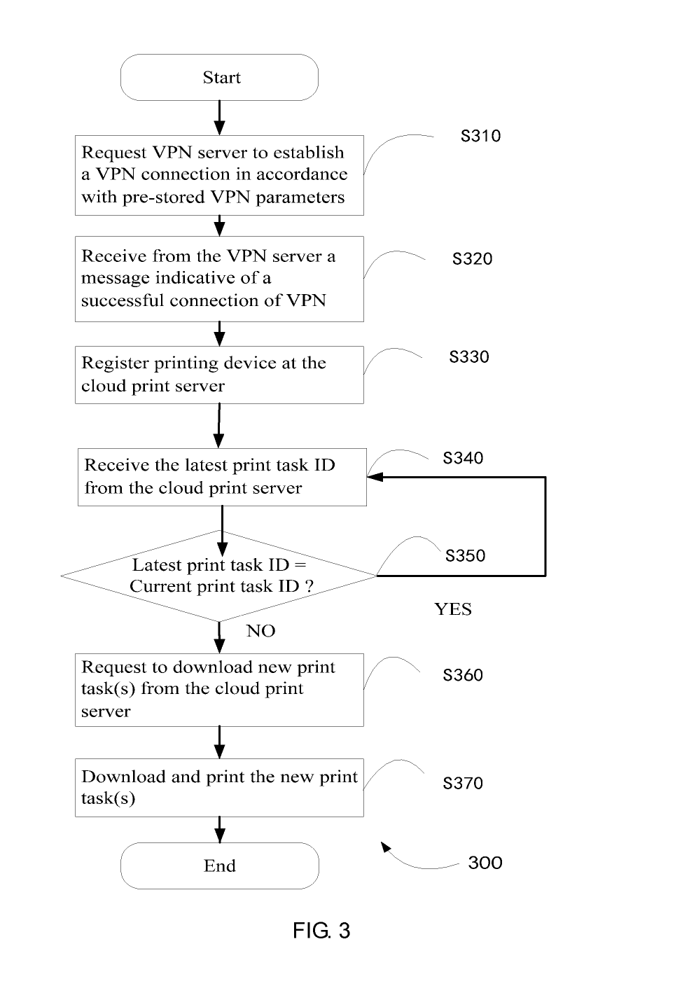

FIG. 3 illustrates a flow chart of a printing method executed by a printing device according to one embodiment of the present invention.

As step S310, a printing device, e.g., a print box or a printer with a cloud printing function, requests the VPN server to establish a VPN connection in accordance with the pre-stored VPN parameters, the VPN parameters comprising an IP address of the VPN server and a domain name of the printing device, wherein the domain name of the printing device is bound to the hardware id of the printing device. At step S320, the printing device receives a message indicative of a successful establishment of VPN connection from the VPN server. At step S330, the printing device registers itself at the cloud print server. At step S340, the printing device receives from the cloud print server the latest print task ID in the print task list. The latest print task ID may be acquired either by “pull”, i.e., the printing device periodically inquires of the cloud print server 120 about the latest print task ID in the print task list, or by “push”, i.e., the printing device receives the latest print task ID pushed by the cloud print server. As step S350, the printing device compares the received latest print task ID with the current print task ID maintained in the printing device. If the two print task IDs are inconsistent, it requests at step S360 to download new print task(s) from the cloud print server, the new print task(s) corresponding to the print task ID(s) between the latest print task ID and the current print task ID, i.e. print task ID(s) subsequent to the current print task ID maintained in the printing device. At step S370, the printing device downloads and prints the new print task(s). If the two print task IDs are consistent, it returns to step S340.

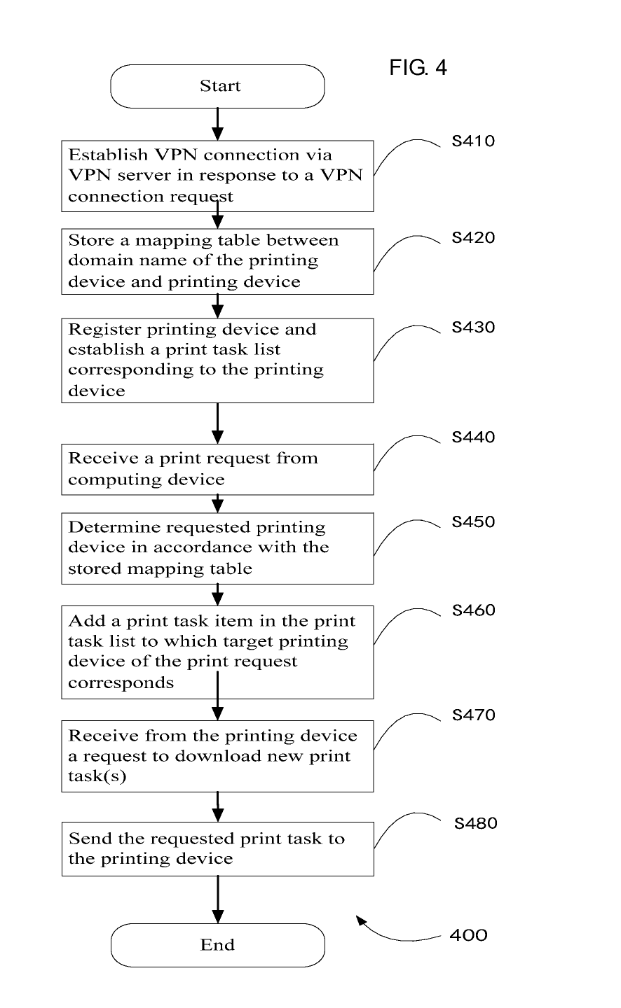

FIG. 4 illustrates a flow chart of a printing method executed by a cloud print server according to one embodiment of the present invention.

At step S410, in response to a VPN connection request comprising VPN parameters from a printing device, the cloud print server establishes a VPN connection to the printing device via a VPN server, the VPN parameter comprising an IP address of the VPN server and a domain name of the printing device, wherein the domain name of the printing device is bound to the hardware id of the printing device. At step S420, a mapping table between the domain name of the printing device and the printing device is stored. At step S430, the cloud print server registers the printing device and creates in the print task memory a print task list corresponding to the printing device. At step S440, a print request from a computing device is received, wherein the print request may comprise the domain name of the printing device. At step S450, the requested printing device is determined based on the stored mapping table, and at step S460 a print task entry is added in the print task list corresponding to the requested printing device. The entry may comprise a print task ID and print task content. The print task ID may increase one by one or increase by the time stamp. At step S470, the cloud print server receives from the printing device a request to download new print task(s), the new print task(s) corresponding to the print task ID(s) subsequent to the current print task ID maintained in the printing device 130. At step S480, the cloud print server sends the requested print task to the printing device.

It is to be understood that in order to make the disclosure concise and one or more of the inventive aspects understood, individual features of the present invention are sometimes grouped together into a single embodiment, drawing or description thereof in the above description of the exemplary embodiments of the present invention. However, the disclosed method should not be construed to reflect an intention that the claimed present invention claims more features than those explicitly stated in each claim. More specifically, as reflected in the claims below, the inventive aspect contains less than all features of an individual embodiment disclosed above. Thus, the claims abiding by the detailed description are hereby explicitly incorporated into the specific embodiments, wherein each claim per se serves as a single embodiment of the present invention.

Those skilled in the art should understand that the modules or units or components of the devices in the examples disclosed herein can be arranged in a device as described in the embodiment, or can alternatively be positioned in one or more devices different than the exemplary device. The modules in the aforementioned examples can be combined into one module or beyond this divided into a plurality of sub-modules.

Those skilled in the art can understand that the modules in the devices of the embodiments can be modified adaptively and arranged in one or more devices different than the embodiment. The modules or units or components in the embodiments can be combined into one module or unit or component, and they can be further divided into a plurality of sub-modules or sub-units or sub-components. Any combination of the features and/or process or units can be used to combine all features disclosed in this specification (including the accompanying claims, abstract and drawings) and any method or all processes or units of the devices as such disclosed, except that at least some of such features and/or processes and/or units are repulsive to each other. Unless specified otherwise, each feature disclosed in the present specification (including the accompanying claims, abstract and drawings) can be substituted by a substitutive feature that provides an identical, equivalent or similar goal.

In addition, those skilled in the art can understand that although some embodiments mentioned herein comprise certain features comprised in other embodiments instead of other features, the combination of features from different embodiments implies that they fall within the scope of the present invention and form different embodiments. For example, in the following claims, any one of the claimed embodiments can be used in arbitrary combinations.

In addition, some of the embodiments herein are described as a combination of the methods or method elements implemented by a processor of a computer system or by other devices executing said functions. Therefore, a processor having instructions necessary for implementing the methods or method elements forms a device for implementing the methods or method elements. Moreover, the elements of the device embodiments mentioned herein are examples of devices that are used to implement the functions executed by the elements for implementing the goal of the invention.

As is used herein, unless specified otherwise, the description of an ordinary object with ordinal numbers “first”, “second”, “third” and the like only represents that different instances of similar objects are involved, and is not intended to imply that the objects as such described must have any given orders temporally, spatially, sequentially or in any other manner.

Although the present invention is described in dependence on a limited number of embodiments, owing to the above description, one skilled in the art is aware that other embodiments can be envisaged within the scope of the present invention described herein. In addition, it should be noted that the language used in the present specification is selected for the purpose of readability and teaching, rather than for explaining or defining the subject matter of the invention. Therefore, if not deviating from the scope and spirit of the attached claims, many modifications and changes are clear for those of ordinary skills in the art. For the scope of the present invention, the disclosure of the invention is illustrative, not restrictive, and the scope of the invention is defined by the appended claims.

1. A network print server, comprising:
a print task memory configured to store a print task list;
a printing device registration unit configured to establish, in response to a VPN connection request comprising VPN parameters from a printing device, a VPN connection to the printing device via a VPN server, register the printing device and create in the print task memory a print task list corresponding to the printing device, the VPN parameters comprising an IP address of the VPN server and a domain name of the printing device, wherein the domain name of the printing device is bound to a hardware id of the printing device; and
a print task management unit configured to receive a print request from a computing device and add a print task entry in the print task list of the requested printing device, the print task entry comprising a print task ID and print task content,
wherein the print task management unit is further configured to receive from a printing device a request to download the print task and send the requested print task to the printing device.

2. The network print server according to claim 1, wherein the network print server and the VPN server are located in the same internal network.

3. The network print server according to claim 1, wherein the printing device registration unit is further configured to store a mapping table between the domain name and the printing device, and wherein the print task management unit is further configured to determine the requested printing device based on the domain name in the print request.

4. The network print server according to claim 1, wherein the print task management unit is further configured to push the latest print task ID in the print task list to the corresponding printing device.

5. The network print server according to claim 1, wherein the VPN connection is established by n2n.

6. A printing method, comprising:
establishing, in response to a VPN connection request comprising VPN parameters from a printing device, a VPN connection to the printing device via a VPN server, wherein the VPN parameters comprise an IP address of the VPN server and a domain name of the printing device, wherein the domain name of the printing device is bound to the hardware id of the printing device;
registering the printing device and creating in a print task memory a print task list corresponding to the printing device;
receiving a print request from a computing device;
adding a print task entry in the print task list of the requested printing device, the print task entry comprising a print task ID and print task content;
receiving from the printing device a request to download a print task; and
sending the requested print task to the printing device.

7. The method of claim 6, wherein the network print server and the VPN server are located in the same internal network.

8. The method of claim 6, further comprising:
storing a mapping table between the domain name and the printing device; and
determining the requested printing device based on the domain name in the print request.

9. The method of claim 6, further comprising pushing the latest print task ID in the print task list to the corresponding printing device.

10. The method of claim 6, wherein the VPN connection is established by n2n.

11. The method of claim 6, further comprising:
requesting a VPN server to establish a VPN connection based on pre-stored VPN parameters and registering the printing device at the network print server, wherein the VPN parameters comprise an IP address of the VPN server and a domain name of the printing device, wherein the domain name of the printing device is bound to the hardware id of the printing device;
receiving from the network print server the latest print task ID in the print task list; and
comparing the latest print task ID of the printing device provided by the network print server with the current print task ID maintained in the printing device, and requesting to download at least one new print task from the network print server if the two print task IDs are inconsistent, the at least one new print task corresponding to at least one print task ID subsequent to the current print task ID maintained in the printing device.

12. The method of claim 11, further comprising switching between a VPN connection mode and a non-VPN connection mode.

13. The method of claim 11, wherein the receiving step comprising receiving the latest print task ID in the print task list pushed by the network print server.

14. The method of claim 11, further comprising testing whether the network is smooth prior to the requesting for the establishment of the VPN connection.

15. A network printing system, comprising a network print server and at least one network printing device,
wherein the network print server comprises:
a print task memory configured to store a print task list;
a printing device registration unit configured to establish, in response to a VPN connection request comprising VPN parameters from a printing device, a VPN connection to the printing device via a VPN server, register the printing device and create in the print task memory a print task list corresponding to the printing device, the VPN parameters comprising an IP address of the VPN server and a domain name of the printing device, wherein the domain name of the printing device is bound to a hardware id of the printing device; and
a print task management unit configured to receive a print request from a computing device and add a print task entry in the print task list of the requested printing device, the print task entry comprising a print task ID and print task content,
wherein the print task management unit is further configured to receive from a printing device a request to download the print task and send the requested print task to the printing device;
wherein the network printing device comprises:
a network initialization unit configured to request a VPN server to establish a VPN connection based on pre-stored VPN parameters, register the printing device at the network print server, wherein the VPN parameters comprise an IP address of the VPN server and a domain name of the printing device, wherein the domain name of the printing device is bound to a hardware id of the printing device; and
a print task management unit configured to receive from the network print server the latest print task ID in the print task list, compare the latest print task ID of the printing device provided by the network print server with the current print task ID maintained in the printing device, and request to download a new print task from the network print server if the two print task IDs are inconsistent, the new print task corresponding to the print task ID subsequent to the current print task ID maintained in the printing device.

16. The network printing system according to claim 15, wherein the network printing device further comprises a printing unit configured to execute a print task assigned by the print task management unit.

17. The network printing system according to claim 16, wherein the network initialization unit and the print task management unit are located in a printing box outside of the printing unit.

18. The network printing system according to claim 15, wherein the network initialization unit is further configured to switch between a VPN connection mode and a non-VPN connection mode.

19. The network printing system according to claim 15, wherein the print task management unit is further configured to receive the latest print task ID in the print task list pushed by the network print server.

20. The network printing system according to claim 15, wherein the network initialization unit is further configured to test whether the network is smooth prior to the requesting for the establishment of the VPN connection.
